(19) United States
(12) Patent Application Publication
(10) Pub. No.: US 2005/0243278 A1
(43) Pub. Date: Nov. 3, 2005

(54) Method and facilities for watching 3D movies

(76) Inventors: Ming Li, Shenzhen (CN); Zhigang Rong, Shenzhen (CN); Jingyi Gao, Shenzhen (CN); Daoqiang Liu, Shenzhen (TW); Liang Ding, Shenzhen (TW)

Correspondence Address: Hytechnology Inc., Suite 200, 8275 South Eastern Avenue, Las Vegas, NV, 89123, US

(21) Appl. No.: 11/103,585

(22) Filed: Apr. 12, 2005

(30) Foreign Application Priority Data
Apr. 28, 2004 (CN) 200410027127.9

(51) Int. Cl. G03B 21/32

(52) U.S. Cl. 352/57; 352/86

(57) ABSTRACT

The invention provides possible methods and facilities of watching movies in common theaters. A watching method includes: installing two projectors, each showing respectively a picture plane of a pair of 3D frames; synchronous manipulation making the two projectors alternate in light transmission and light block one in light transmission another in light block; alternating with each other: synchronous signals sending to liquid crystal polarizing glasses; a liquid crystal light valve and projectors alternating with each other synchronously to make audience see the left picture with left eye and right picture with right eye and form the complete 3D picture. The invention can improve the bright evenness of the pictures, easy to maintain screen and to embrace common and 3D movies only if used in existing film projectors or video projectors. It only needs to press a switching button without changing lens and screens, suitable to remold existing common theaters into embracing common and 3D theaters.

### FIELD OF THE INVENTION

This invention involves methods and facilities of 3D movies.

### BACKGROUND

3D movies are well known to people, and devices and technologies vary in displaying 3D pictures, but they all make use of optical parallax between left and right eyes of people and form the 3D images in their minds.

A technology adopted universally and appropriate to a large number of audience watching movies on the same scene is polarized light one, which requires generation of a pair of mutual polarized lights projecting respectively on left and right frames of 3D pictures. Audiences wear polarized glasses to make a left frame into the left eye and a right frame into the right eye so as to form the complete 3D picture. The technology has a certain requirement for the screen which guarantees that the polarized light projected by projectors will not be destroyed, that is, no changes will occur in light vibration through reflection and transmission of the screen so that a so-called “metal screen” is adopted. However, there exists a deficiency. The light direction is so strong that the audiences can feel the uneven frame brightness from different positions (esp. on a curved screen); the audiences have to keep horizontal vision and cause the polarized direction of the lens to be consistent with that of the projectors. The requirement is not appropriate to watching movies on the motion base. It's difficult to maintain the metal screen; its light is uneven, the audience's posture is restricted and the curved screen affects polarized features.

There are other technologies such as a color filtering film, which has effects on restoration to the original colors, a prism grating technology, which has a requirement for watching distance, and other technologies, which cannot be used at present in common theaters.

### SUMMARY OF THE INVENTION

The invention is designed to avoid the deficiencies mentioned above and to provide possible methods and facilities for watching movies in common theaters. An aim of the invention can be realized by designing a way of watching the 3D movies including the following steps:

A. Installing two projectors, each of which shows respectively a picture plane of a pair of 3D frames;

B. Synchronous manipulation, which enables the two projectors to alternate between light transmission and light block, that is, one is in light transmission while the other is in light block, and the two alternate with each other;

C. Synchronous signals sent to the liquid crystal polarizing glasses; a liquid crystal light valve and projectors alternate with each other synchronously so that the audience can see the left picture plane with the left eye and right picture plane with the right eye, both of which form the complete 3D picture.

The aim of the invention can also be realized by designing facilities of watching 3D movies including projection facilities, projected picture display facilities and liquid crystal light valve glasses, and

Synchronous drivers, used to control the synchronous running of projectors or shutters;

Shutters, installed on a light transmission passage between light source and projected picture display facilities;

Shutter sensors, sending synchronous signals to liquid crystal light valve glasses pursuant to inductive or sensed light transmission or lightproof signals.

Compared with existing technologies, this invention can improve the bright evenness of the pictures, and make it easy to maintain the screen and embrace. While the invention is used together with film projectors or video projectors, both the common movies and the 3D movies could be compatible. In daily show, it is only necessary to press a switching button without changing the lens and the screens, which is suitable to remold the existing common theaters into those embracing both common and 3D theaters and which is of tremendous social and economic benefits; it is appropriate to all kinds of quality materials and screens; it is suitable for special films of all kinds without any requirements of the postures of the audiences.

### BRIEF DESCRIPTION OF THE DRAWINGS

FIG. 1 is a principle schematic diagram of Embodiment 1.

FIG. 2 is a principle schematic diagram of Embodiment 2.

FIG. 3 is a time sequence diagram of embodiments.

FIG. 4 is a synchronized film controlling diagram of Embodiment 1.

### DETAILED DESCRIPTION OF THE INVENTION

The following are further descriptions combined with embodiments.

A method of watching 3D movies, including:

A. Installing two projectors, each of which shows respectively a picture plane of a pair of 3D frames;

B. Synchronous manipulation, which enables the two projectors to alternate in light transmission and light block, that is, one is in light transmission while the other is in light block; and the two alternate with each other:

C. Synchronous signals sent to liquid crystal light valve glasses; liquid crystal light valve and projectors alternate with each other synchronously so that the audience can see the left picture plane with the left eye and right picture plane with the right eye, both of which form a complete 3D picture.

The Step C includes that liquid crystal light valve glasses receive synchronous signals from shutter sensor, control liquid crystal light valve and enable liquid crystal light valve and projectors to alternate synchronously.

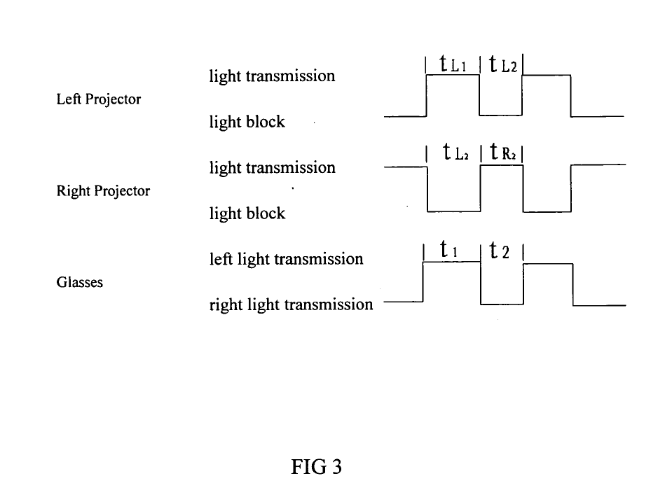

As shown in FIG. 3, the time of light transmission of the projectors is no more than that of the light block and time of light transmission of the left projector is equal to that of the right one; the time of light transmission of the left lens is equal to that of the right one, that is, the rate of duty cycle is 50% and the rising edge of the left light transmission is synchronous with that of the light transmission of the left projector; the rising edge of the right light transmission is synchronous with that of the light transmission of the right projector;. The time of the light transmission of the left projector is correspondingly synchronous with that of the left lens and the left eye can only sees the left picture plane and the right eye can only see the right picture plane so as to form the complete 3D picture.

The 3D movie watching facilities include those of the film projection, the projected picture display facilities, the liquid crystal light valve glasses and also the synchronous driver used as manipulating synchronous movement of the projectors or the shutters;

The shutter, installed on the light transmission passage between light sources and projected picture display facilities;

The shutter sensor, sending out the synchronous signals to the liquid crystal light valve glasses pursuant to the sensed light transmission and the light block signals;

The projection facilities include at least two projectors, among which one is a left frame projector and the other is a right frame projector.

When light block rate of shutter is no less than 48 Hz, the audiences cannot see the obvious glittering.

The liquid crystal light valve glasses are made with liquid crystal technologies. By means of electronic control, liquid crystal is turned and reaches the aims of the light transmission or the light block so that left and right eyes can alternate to see the picture. If the left eye sees the left frame of the 3D picture and the right eye sees the right frame of the 3D picture, then the 3D image can be formed in the mind. Pursuant to research and experiment results, the audience cannot see the obvious glittering at 50 Hz of alternate frequency rate between the left and the right eyes. The liquid crystal glasses are equipped with a signal receiver and a controlled electrode. The former receives controlled signals and transform and output them to the electrode; the latter controls open and close of the liquid crystal lens. The signal receiver can adopt both manners of wireless signal reception and wired transmission reception.

The shutter sensors can either transmit synchronous signals directly to the liquid crystal light valve glasses by the signal line or install a wireless transmission device in the shutter sensor to transmit the synchronous signals to the wireless receiving device of the liquid crystal light valve glasses by the wireless transmission device.

Projected picture display facilities may be common film screen, or white wall, etc.

The film based projector projects a series of frames on the screen with a set of motor-driven film winding mechanisms at 24 fps so that the audience can see the constant movement of the picture. The film projector cuts off the light source in the film projection so that the audience cannot see the process of the film winding. Since electricity cannot be frequently connected or cut off a xenon lamp, a physical method is adopted to prevent the light source from shooting to the screen through films. The constant light transmission or the light block will cause glitters without proper control. Therefore, in reality light of each frame is transmitted twice and blocked twice alternatively and the film projector winds the film on the second light block.

The invention makes use of the working process and arranges two film projectors for synchronous connected work. While one is on the transmission light, the other is off the transmission light, and both run alternately in cycle projecting a pair of left and right eye frames alternately on the screen and making use of the liquid crystal light valve glasses synchronously connected with the frames to cause the audience to see left frame with left eye and right frame with the right eye and form the complete 3D picture in the mind.

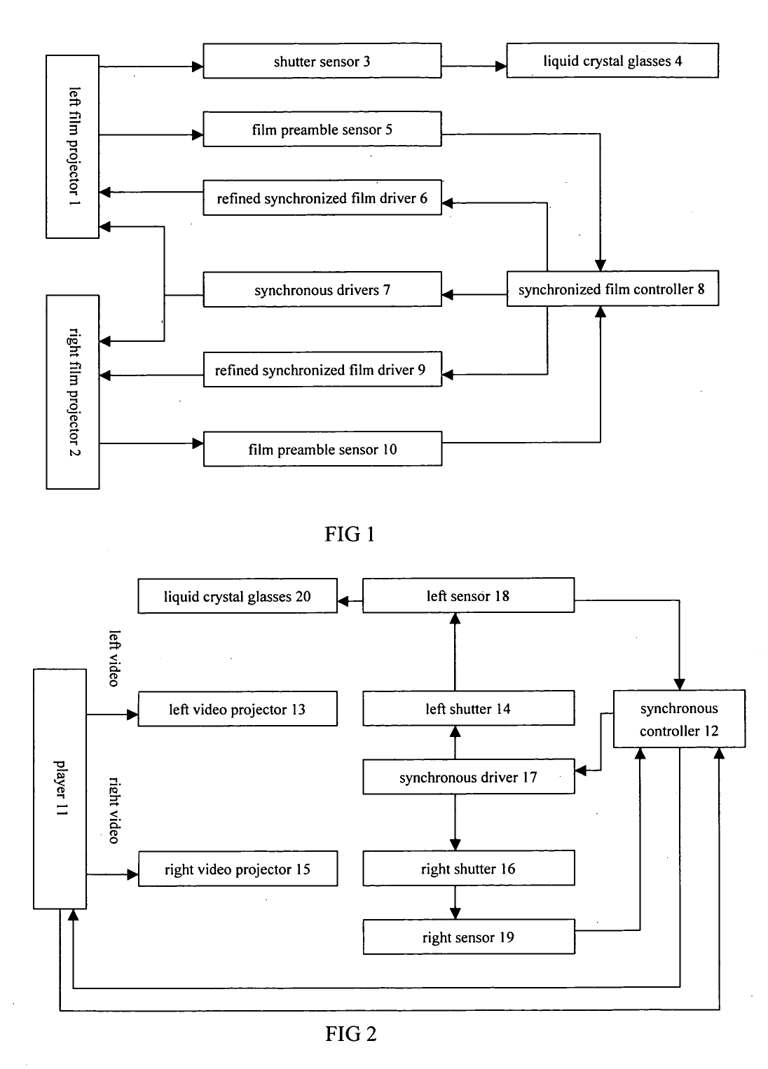

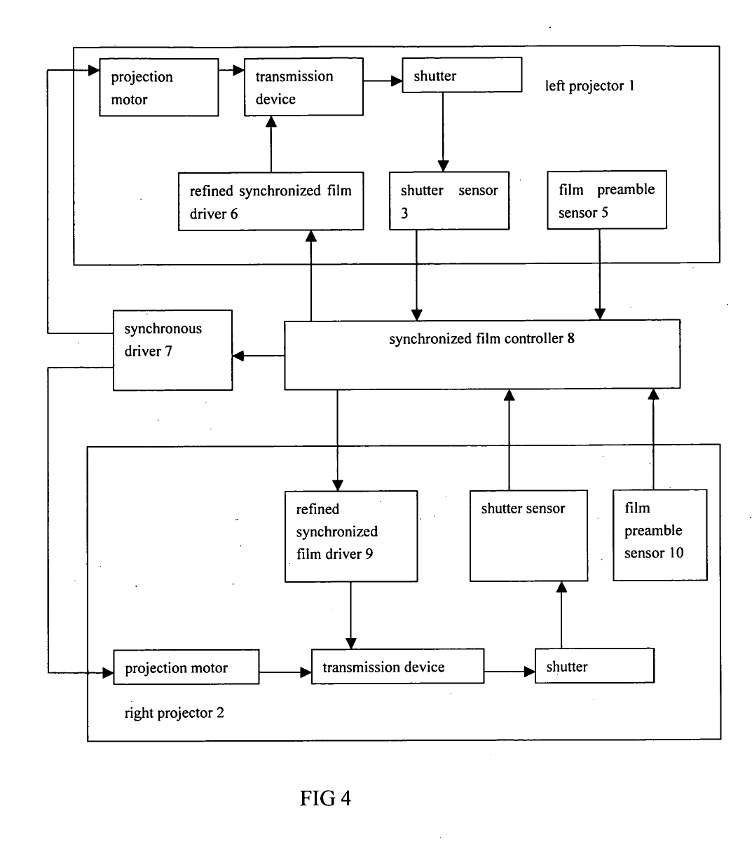

As shown in FIG. 1 and FIG. 4, the projector described is a film based projector which includes film winding mechanism, light source, shutter, film gate, lens and projection motors; there exists synchronized film mechanism including synchronized film controllers (8), respectively installed on film preamble sensors (5) and (10) of left and right projectors, which transmit signals to synchronized film controllers (8); synchronous drivers (7) control film projection mechanism of left and right projectors. film preamble sensors (5) and (10) are connected with synchronized film controller (8) and the latter is connected with synchronous driver (7).

The synchronized film mechanism including refined synchronized film drivers (6) and (9) controls speed of film winding mechanism.

In the embodiment, the synchronous, drivers (7) adopt electrical source transducer to control the speed of projection motors by controlling power supply and realize low speed in the synchronized film projection and high speed in projection.

As film based projectors, the Step B described, including: b11. Operating the film preamble before the show, that is, the two projectors put the starting frame of the film frame ready for show to aim at film gate and the synchronized controller and synchronous driver drive the two projectors to show the film in a slow speed. When the film preamble sensor of one projector transmits the film preamble signals in position to the synchronized controller, the latter stops the machine and the other projector continues to show the film and does not stop until the film sensor transmits the film preamble signals in position to the synchronized controller;

b12. Pausing the shutters of the two projectors in correct position, that is, pausing the shutter of the left one in the light transmission position and the shutter of the right one in the light block position.

The Step b11 includes establishment of film preamble symbols on the film by which film preamble sensors sense signals of film preamble in position.

In the synchronized film operation, first of all, start the refined synchronized film driver to cause shutter to cease on 0° position. Since the transmission devices of the film projectors work at intervals, herein they complete one time film winding, the position of the shutter transmitting light is defined on 0° (starting point). Then, stick tinny foil on a certain frame (Frame 10 for example) in front of the positive and the left and right eye film should be in consistent. Put the films hanging on the projector and guarantee to fix the complete frame to the film gate. After that, put on frequency conversion power supply and start the projection motors to cause two film projectors to run in a synchronized film mode. At the time the film projector moves slowly. When the film symbol sensor of a certain film projector find the symbols on the films, the film projector stops and synchronized film controller 8 does not stop until it continues to control the other film projector and find the symbols of the films. Again, start refined synchronized film motors to cause shutter of left-eye projector to move to 0° (360°) and that of the right-eye projector move to −90° (270°). Thus the whole process of the synchronized film is completed.

After accomplishing the synchronized film process, start playing. The shutter sensor 3 will send out the synchronous signals of the light transmission and the light block of the projectors to the liquid crystal light valve glasses 4, in which the controllers control on or off of the left-eye or the right-eye light valves. The left eyes of the audience can only see the left frames and their right eyes can only see the right frames so that they form the complete 3D picture in the minds of the audiences.

FIG. 2 shows the implementation plan of the projectors described as video projectors. Because the structure of the video projectors is small and compact, add the shutter to front of the lens without any internal modification. If the video projector is used only in displaying the 3D movies, the shutter can be installed inside the video projector, which takes on an integration with the video projector.

The projector described are video projectors; player 11, the left and the right video projectors connected respectively to player 11, which controls video synchronous display of the left and the right video projectors 13 and 15 and transmit the starting signals to synchronous controller 12; install shutter 14 and 16 respectively on light transmission passage described in front of the Left and the right video projectors 13 and 15; install shutter sensors 18 and 19 on the Left and Right shutter 14 and 16, among which the sensor 18 will transmit the synchronous signals to the liquid crystal light valve glasses and the other sensor 19 will feedback the synchronous signals to the synchronous controller 12; the synchronous controller 12 controls synchronous driver 17; the synchronous driver 17 controls left and the right shutter 14 and 16.

The shutters can adopt block lens to block light reeling or to and fro. The shutters are mainly composed of driving motor and light block sheets.

As for the projector defined as video projector, the Step B including:

b21. Installing shutter respectively on the light transmission passage between two projectors and the screen;

b22. Player apparatus described send out starting and controlling signals to synchronous controllers which cause left and right shutter to stop on mutual intersection, that is, left light transmission and right light block by synchronous drivers;

b23. Having received synchronous signals sent out by synchronous controllers, player apparatus begin to play 3D films and cause synchronous controllers to drive synchronously left and right shutters to run.

During the operation, the player 11 sends out the starting and controlling signals to the synchronous controller 12, which causes the left and the right shutters 14 and 16 to stop mutual intersectional position, that is, the left light transmission and the right light block through the synchronous driver 17. After receiving the synchronous signals sent out by the synchronous controller 12, the player 11 begins to play the 3D movies and drives the left and right shutters 14 and 16 to work by the synchronous controller 12 and the synchronous driver 17; the liquid crystal light valve glasses 20 receive the synchronous signals from the left sensor 18 and control the liquid crystal light valves. Wearing the liquid crystal light valve glasses, the audiences of the 3D movies can only see the left frame with the left eye and the right frame with the right eye so as to make use of optical parallax to form the complete 3D picture in the mind.

1. A method of watching 3D movies, comprising:
A. installing two projectors, each of which shows respectively a pair of left-eye and right-eye picture of 3D frames;
B. alternating two projectors in light transmission and light block by synchronous manipulation, that is, one is in light transmission while the other is in light block; and the two alternate with each other; and
C. sending synchronous signals to liquid crystal light valve glasses to enable liquid crystal light valve and projectors to alternate with each other synchronously and to enable the audience to see the left picture plane with the left eye and the right picture plane with the right eye, both of which form a complete 3D picture.

2. The method of watching 3D movie of claim 1, wherein the time of light transmission of the projector is no more than that of light block, and the time of light transmission of the left projector is equal to that of the right one; the time of light transmission of the left lens is equal to that of the right one, that is, the rate of duty cycle is 50%; the rising edge of left light transmission is synchronous with that of light transmission of left projector.

3. The method of watching 3D movie of claim 1, wherein the Step B further comprising:
b11. operation of the film preamble before showing, i.e. the two projectors put the starting frame of the film preamble ready for show to aim at film gate and the synchronized firm controller and synchronous driver drive the two projectors to wind the film at a slow speed. When the film sensor of one projector transmits the preamble signals in position to the synchronized film controller, the latter stops the machine and the other projector continues to wind the film and does not stop until the film sensor transmits the preamble signals in position to the synchronized film controller; and,
b12. pausing the shutters of the two projectors into correct position, that is, pausing the shutter of the left one in light transmission position and the shutter of the right one in light block position.

4. The method pursuant to claim 3, wherein the Step b11 further comprising of setting symbols on the preamble of the film.

5. The method pursuant to claim 1, wherein the Step B further comprising:
b21. installing shutters respectively on light transmission passages between the screens and the two projectors; and,
b22. controlling signals sent out by the player to start the synchronous controller, which causes the left and right shutters pause into a mutual intersection through the synchronous driver, the left light transmission and right light block; and,
b23. a 3D film played after receiving the synchronous signals sent by the synchronous controller, and the left and the right shutters driven synchronously to run through synchronous controller.

6. The method pursuant to claim 1, wherein the Step C further comprising:
liquid crystal light valve glasses receive synchronous signals from the shutter sensor, control liquid crystal light valve and enable liquid crystal light valve and film projectors to alternate synchronously.

7. A 3D movies watching facilities comprising projection facilities, projected picture display facilities and liquid crystal light valve glasses, further comprising:
synchronous driver, used as manipulating synchronous movement of film projectors or shutters;
shutter, installed on light transmission passage between light sources and projected picture display facilities; and
shutter sensor, sending out synchronous signals to liquid crystal light valve glasses pursuant to inductive or sensed light transmission and light block signals;
said projection facilities include at least two projectors, among which one is a left frame projector and the other is a right frame projector.

8. The 3D movie watching facilities pursuant to claim 7, wherein said projectors are film based projectors comprising:
film winding mechanism, light source, shutter, film gate, lens, and projecting motor;
synchronized film mechanisms including synchronized film controllers (8) installed respectively on film preamble sensor (5) and (10), which send signals to synchronized film controller (8);
synchronous drivers (7), film winding mechanism of controlling film projectors (1) and (2); and,
film preamble sensors (5) and (10) are connected with synchronized film controllers (8) and synchronized film controllers (8) are connected with synchronous drivers (7).

9. The 3D movie watching facilities pursuant to claim 8, wherein synchronized film outfits comprising: refined synchronized film drivers controlling the speed of film winding mechanism.

10. The 3D movie watching facilities pursuant to claim 7, wherein said projectors are video projectors, comprising:
players (11), which are connected respectively with left and right video projectors (13) and (15), receive synchronous signals sent from synchronous controllers (12) to control synchronous video play and feedback the synchronous signals to synchronous controllers (12); and,
shutters (14) and (16) on the light transmission passage in front of the left and right video projectors (13) and (15) respectively; and,
shutter sensor (18) and (19) respectively on the left and right shutters (14) and (16), among which one shutter sensor (18) sends synchronous signals to liquid crystal light valve glasses (20) and the other (19) feedbacks synchronous signals to synchronous controller (12); and,
synchronous controller (12) controls synchronous drivers (17); synchronous drivers (17) control left and right shutters (14) and (16).
